(19) United States
(12) Patent Application Publication
(10) Pub. No.: US 2025/0361858 A1
(43) Pub. Date: Nov. 27, 2025

(54) Air Station

(71) Applicant: Scanstrut, Inc., Westbrook, CT (US)

(72) Inventors: George Bowles, Exeter (GB); Nigel Smith, Exeter (GB)

(21) Appl. No.: 18/873,210

(22) PCT Filed: Jun. 20, 2023
(86) PCT No.: PCT/US2023/025780

§ 371 Date: Dec. 9, 2024

Related U.S. Application Data
(60) Provisional application No. 63/353,166, filed on Jun. 17, 2022.

(51) Int. Cl. F04B 39/12; B60R 16/08

(52) U.S. Cl. CPC F04B 39/121; B60R 16/08; F04B 39/123

(57) ABSTRACT

Apparatus, systems and methods for providing a low voltage DC-powered, waterproof, panel- mounted air pump for use with leisure inflatables. The present air station pump apparatus, systems and methods are configured for permanent installation directly into a marine or land vessel (e.g., a boat or recreational vehicle (RV)), are for use in harsh outdoor environments, and are sealed and encapsulated to provide a waterproof installation.

### CROSS REFERENCE TO RELATED APPLICATIONS

This invention disclosure claims priority from PCT/US2023/025780 filed Jun. 20, 2023, which claims priority from U.S. provisional patent application No. 63/353,166 filed Jun. 17 2022.

### TECHNICAL FIELD

This invention relates to apparatus, systems and methods for permanently waterproof installation of an air pump station into a marine/land vessel for use with inflatable devices.

### BACKGROUND ART

Inflatable devices, such as recreational leisure inflatables, must be blown up prior to use thereof. Often air pumps are used to blow up these inflatable devices. Common air pumps include manual pumps, hand pumps, foot pumps, and portable electric pumps. However, depending upon the size of the inflatable device being blown-up, manual, hand and/or foot pumps may take too long, be inconvenient, and be both time and energy consuming. Likewise, portable electric pumps may be inconvenient and time/energy inefficient as a power source needs to be located for blowing up the inflatable. In instances where the inflatable is large and/or for use on a waterway, power sources for portable electric pumps are often not readily available or close to where the inflatable is to be blown up. In these instances, the inflatable is often inflated a distance away from the waterway and then carried to the water. Not only are these approaches to inflating devices laborious and time-consuming, the blown-up inflatable may also be heavy making it difficult to carry to the desired location. For marine and/or land vessels, small portable electric pumps are often used and stored on the vessel after such use. Having to store the portable electric pump and then take it out and plug it in for use thereof is inconvenient, time consuming, and inefficient for blowing up an inflatable device. These are the general areas that embodiments of the invention are intended to address.

### DISCLOSURE OF INVENTION

Bearing in mind the problems and deficiencies of the prior art, it is therefore an object of the present invention to provide improved air pump station apparatus and systems for permanent, waterproof installation into a marine or land vessel for easily and quickly inflating an inflatable device.

It is another object of the present invention to provide improved methods of inflating an inflatable device using a waterproof air pump system that is permanently installed in a marine or land vessel.

A further object of the invention is to provide improved air pump station apparatus, systems and methods that are readily available for use, easy to use, convenient, reliable, waterproof, time-efficient, and compatible with various types of inflatable devices and their respective air inflow and outflow valves.

It is yet another object of the present invention to provide methods of easily and quickly inflating an inflatable device directly on a waterway.

Still other objects and advantages of the invention will in part be obvious and will in part be apparent from the specification.

The above and other objects, which will be apparent to those skilled in the art, are achieved in the present invention which is directed to an air pump system permanently installed in a recreational vehicle. The system includes an air pump station having a frame, a front panel, an intermediate gasket, and a housing that has an outwardly extending housing flange around a periphery of the housing. A water-tight seal is formed by connection of the frame, the front panel, the intermediate gasket, and the outwardly extending housing flange of the housing. This water-tight seal prevents water ingress into the air pump station. An air pump resides in the housing and has working components and circuitry for generating airflow and suction. Outflow and inflow airflow connections extend from the housing and are exposed first and second openings in the front panel. The outflow airflow connection outputs air for inflating an inflatable device, while the inflow airflow connection intakes air from an inflated device for deflating said inflated device. A waterproof door resides on the front panel covering the outflow and inflow airflow connections and provides a watertight seal with a surface of the front panel to prevent water ingress into the outflow and inflow airflow connections. A mounting surface of a moving vessel has an opening that is sized and configured to fit the housing. The housing extends through the opening in the mounting surface while the frame, front panel, intermediate gasket, housing flange, and a waterproof gasket all reside above the mounting surface around the opening and are secured to the mounting surface to provide a water-tight seal around housing flange over the mounting surface.

In another aspect the present invention further provides method of forming an air pump system in a recreational vehicle by providing an air pump station having a frame, a front panel, an intermediate gasket, a housing having an air pump therein, a housing flange, a waterproof gasket, an outflow airflow connection, an inflow airflow connection, and a waterproof door residing on the front panel covering the outflow and inflow airflow connections and providing a watertight seal with a surface of the front panel to prevent water ingress into the outflow and inflow airflow connections. An opening in a mounting surface of a moving vessel is provided and is sized and configured to fit the housing. The air pump station is permanently affixed to the mounting surface in a watertight connection whereby the waterproof gasket resides at a backside of the housing. The housing extends through the opening in the mounting surface while the frame, front panel, intermediate gasket, housing flange, and the waterproof gasket all reside above the mounting surface around said opening. These components are secured to the mounting surface to provide a water-tight seal around the housing flange over the mounting surface. The waterproof door includes one or more hinges to ensure the waterproof door is closed when not in use, and prevents water from entering to the air pump inside the housing.

The present invention further provides a method for inflating and deflating an inflatable device. The method includes providing an air pump station having a frame, a front panel, an intermediate gasket, a housing having an air pump therein, a housing flange, a waterproof gasket, an outflow airflow connection, an inflow airflow connection, and a waterproof door residing on the front panel covering the outflow and inflow airflow connections and providing a watertight seal with a surface of the front panel to prevent water ingress into the outflow and inflow airflow connections. The air pump station is permanently affixed to a mounting surface in a watertight connection whereby the waterproof gasket resides at a backside of the housing. The housing extends through an opening in the mounting surface while the frame, front panel, intermediate gasket, housing flange, and the waterproof gasket all reside above the mounting surface around the opening and are secured to the mounting surface to provide a water-tight seal around housing flange over the mounting surface. A hose and connector are provided, and an inflatable device is inflated or deflated by connecting the hose via the connector to the outflow airflow connection for outputting air to inflate an inflatable device or to the inflow airflow connection for intaking air to deflate an inflated device.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates a perspective front side view of an air pump station apparatus and system for permanently waterproof installation into a marine vessel or land vessel for easily and quickly inflating an inflatable device in accordance with one or more embodiments of the invention.

FIG. 2 illustrates a perspective back side view of the air pump station apparatus and system of FIG. 1 for permanently waterproof installation.

FIGS. 3-4 respectively illustrate perspective front side views of the air pump station apparatus and system of FIG. 1 being permanently installed in a marine or land vessel, and the subsequent permanent installation thereof.

FIG. 5 illustrates a perspective front side view of air inflow and outflow valves of the air pump station apparatus and system of FIG. 1.

FIG. 6 illustrates a perspective front side view of the various components of the air pump station apparatus and system of FIG. 1 in accordance with one or more embodiments of the invention.

FIG. 7 illustrates a perspective front side view of another air pump station apparatus and system for permanently waterproof installation into marine or land vessels in accordance with one or more other embodiments of the invention.

FIG. 8 illustrates a perspective back side view of the air pump station apparatus and system of FIG. 7 for permanently waterproof installation.

FIGS. 9-10 respectively illustrate perspective front side views of the air pump station apparatus and system of FIG. 7 being permanently installed in a marine or land vessel, and the subsequent permanent installation thereof.

FIG. 11 illustrates a perspective front side view of air inflow and outflow valves of the air pump station apparatus and system of FIG. 7.

FIG. 12 illustrates a perspective front side view of the various components of the air pump station apparatus and system of FIG. 7 in accordance with one or more embodiments of the invention.

FIGS. 13A and 13B illustrate various hoses and connectors suitable for use with the various air pump station apparatus and systems of the invention.

FIGS. 14A and 14B show test results of various air pump station apparatus and systems in accordance with one or more embodiments of the invention.

### DESCRIPTION OF THE PREFERRED EMBODIMENT(S)

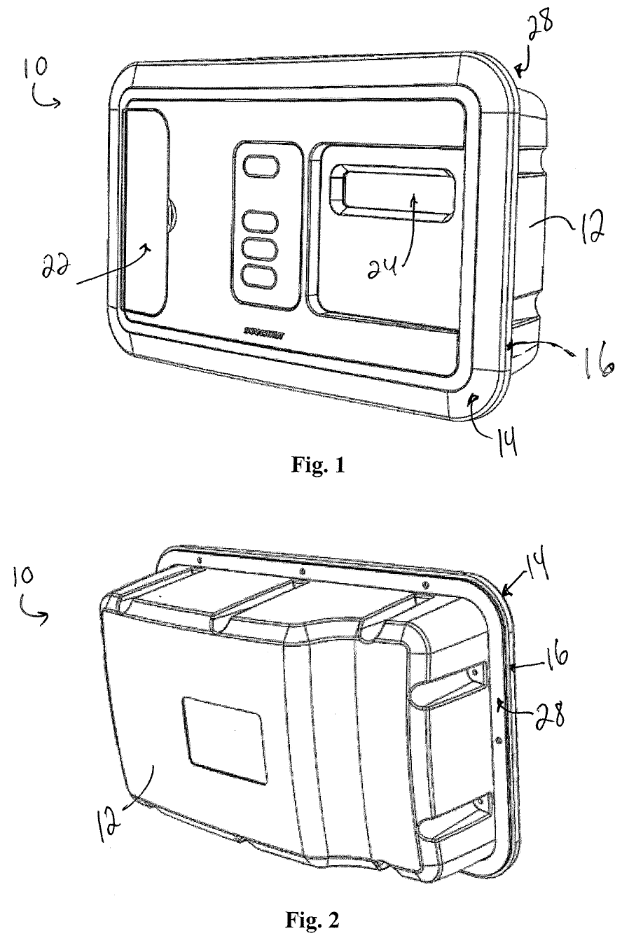

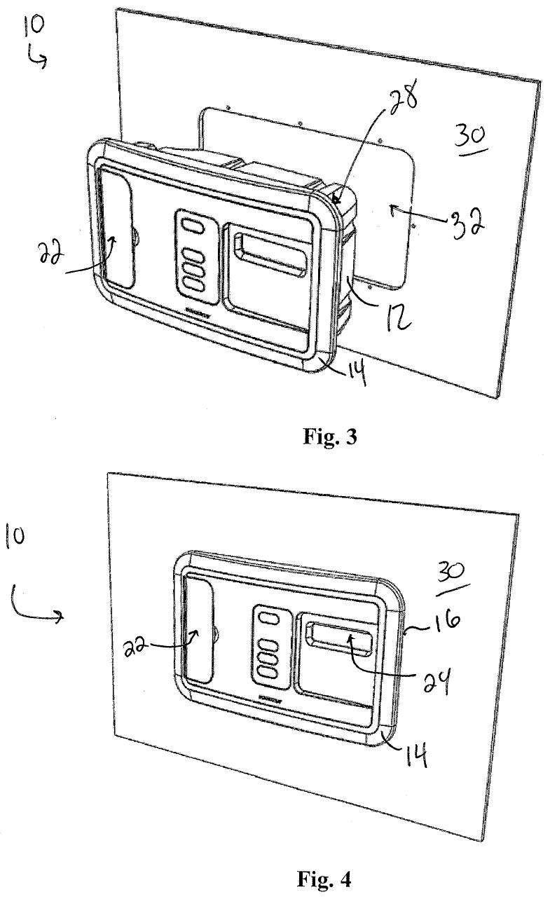

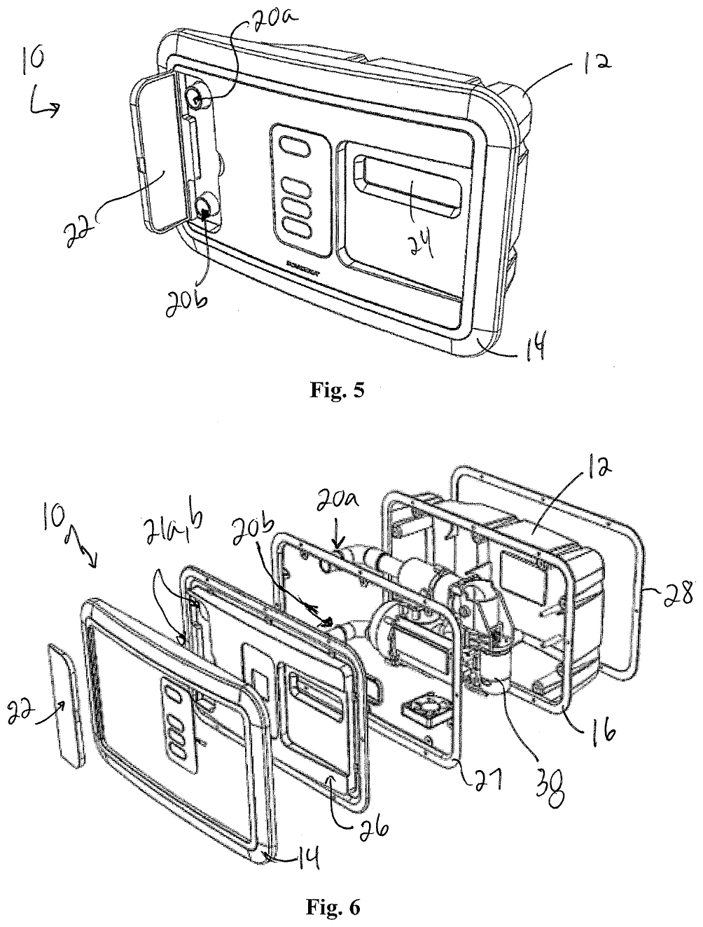

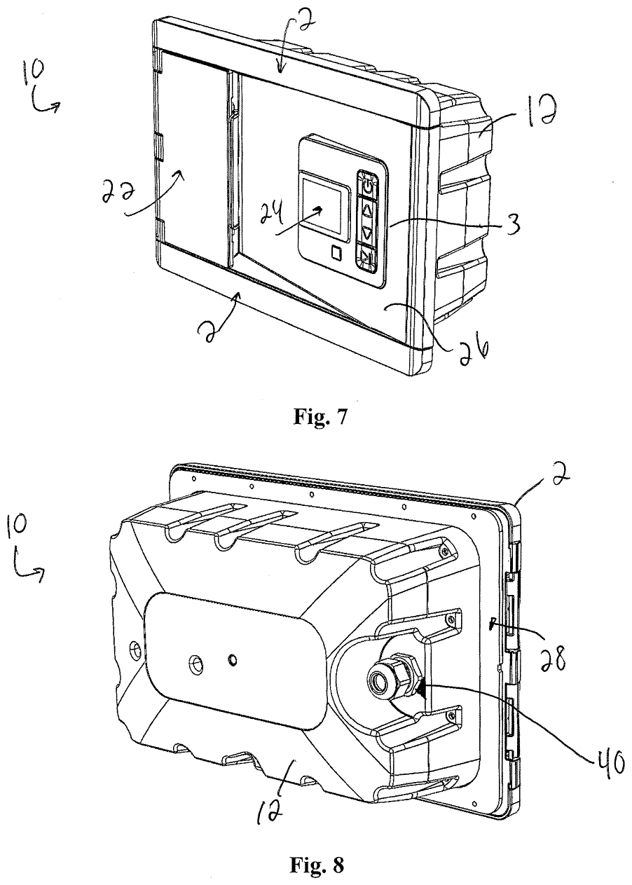

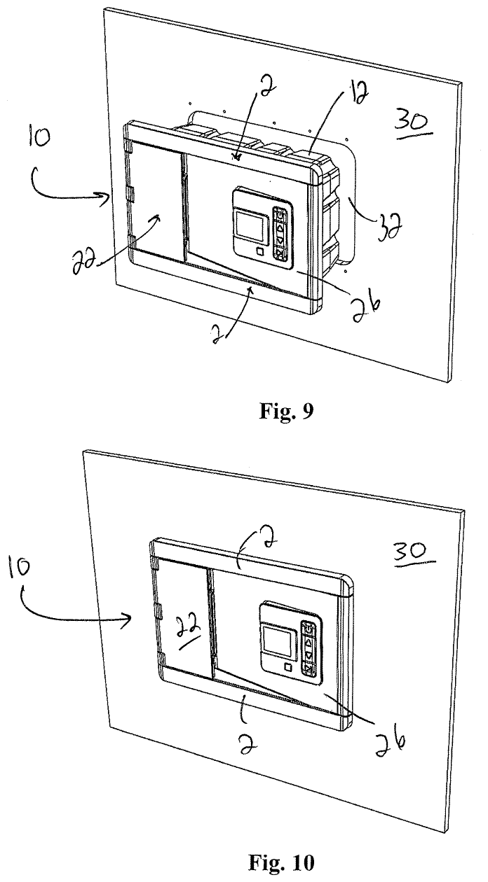

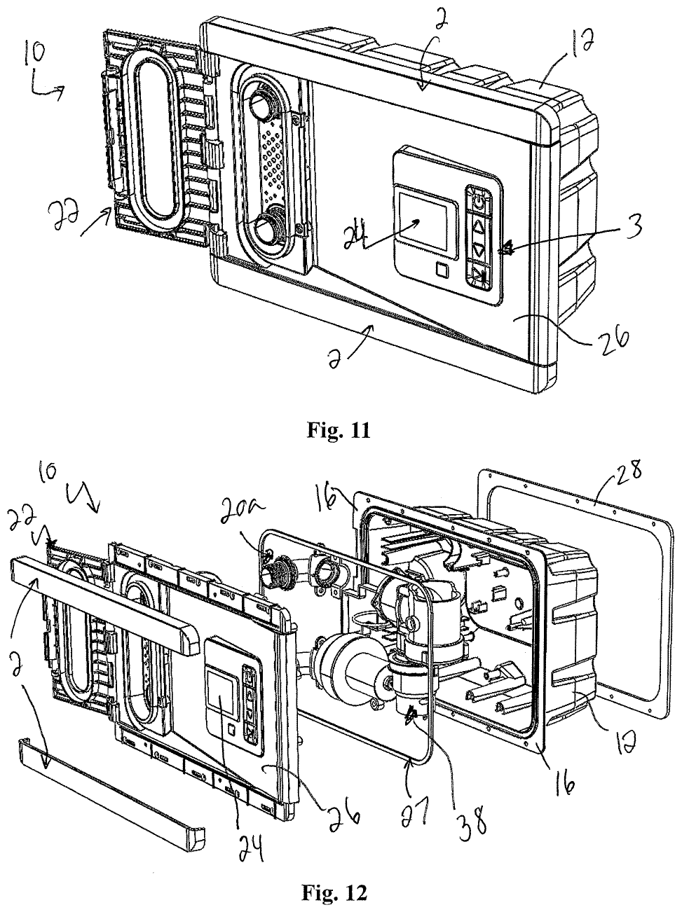

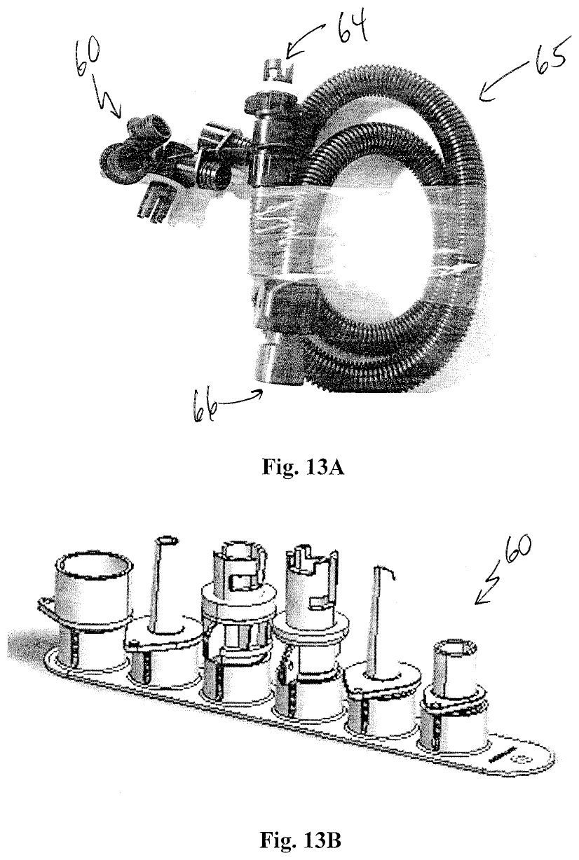

In describing embodiments of the present invention, reference will be made herein to FIGS. 1-14B of the drawings in which like numerals refer to like features of the invention.

In accordance with one or more embodiments, the invention is directed to air pump station apparatus, systems and methods of inflating an inflatable device using the permanently installed, waterproof air pump systems of the invention.

The air station apparatus, systems and methods of the present invention provide a low voltage DC-powered, waterproof, panel-mounted air pump for use with leisure inflatables. The present air station apparatus, systems and methods are configured for permanent installation directly into a marine or land vessel (e.g., a boat or recreational vehicle (RV)), are for use in harsh outdoor environments, and are sealed and encapsulated to provide a waterproof installation.

Referring to FIGS. 1-12, in one or more embodiments air station apparatus and systems include an air pump station 10 having a front frame 14, a front panel 26, an intermediate gasket 27, and a tub-shaped housing 12 with an outwardly extending flange 16 around the periphery. The outer edges of frame 14, front panel 26, gasket 27 and housing flange 16 are correspondingly sized and configured to provide a water-tight seal to prevent water ingress into air station 10. Optionally, in one or more embodiments a waterproof sealant or adhesive may be used in between each of these layers to provide additional waterproofing or watertight connection.

As shown in FIG. 6, the housing 12 holds an air pump 18 therein having various working components and circuitry for generating output air for inflating an inflatable device, as well as intaking air from an inflated device for the deflation thereof. The air pump 18 may be connected to a DC power source (not shown) at a backside of the housing 12 through adapter 40 (see, FIG. 8). The air pump 18 includes an inflow 20a airflow connection for deflation and an outflow 20b airflow connection for inflating an inflatable device. Referring to 13A and 13B, the air pump airflow connections 20a, 20b allow for easy use and connection of various existing hand pump hoses 65 and connectors 60, and are designed to be durable enough for permanent installation and repeated fixing and removing. The hose 65 has a first end 66 for connection to the present air pump station and a second end for connection to the inflatable device in need of inflating.

In one or more embodiments of the invention, the inflow 20a and outflow 20b airflow connections may be protected and covered by a waterproof door 22. The waterproof door 22 may include one or more hinges or latches for easy and secure opening and closing. The door 22 may also include one or more seals on its outer periphery edges and/or on inside perimeter edges to provide a watertight connection and seal with a surface of the front panel 26 when the door 22 is closed. This watertight seal protects the inflow 20a and outflow 20b airflow connections from water ingress. The one or more hinges or latches ensure that the door 22 is closed when not in use, the sealed watertight connection ensures water is prevented from entering to the air pump 18 area inside housing 12.

The front panel 26 of the air pump station may also include a pressure readout screen 24, such as an LCD display 24, for setting a pre-determined pressure of the device to be inflated for avoiding over-inflation thereof. The air pump station may be turned on and off, and the pre- determined pressure settings may be input into the system via push buttons 3 residing at a surface of the front panel 26 and connected to circuitry of the air pump residing in housing 12. In accordance with the invention, selecting PSI or Bar units, setting desired pressures, setting maximum pressures, timing for start or ending pumping, etc.

Referring to FIGS. 6 and 12, in assembling the present air station systems of the invention, the outwardly extending flange 16 of housing 12 mates with correspondingly sized waterproof gasket 28 below the housing flange, or at the backside of housing 12. The gasket 28 has a width comparable to the extension of the flange 16 from the housing 12. The marine or land vessel in which the present air pump station system is to be installed has a mounting surface 30 with a cut-out opening therein 32 that is sized and configured to received housing 12 and flange 16 and gasket 28. In accordance with the invention, the marine or land vessel may include, for instance, a boat, water vessel, ship, RV, motorcycle, automobile, truck, etc. When installed, the housing flange 16 (along with the outer edges of frame 14, front panel 26 and gasket 27) and the gasket 28 are disposed above surface 30, around opening 32. Gasket 28 may have adhesive on the lower surface, or adhesive may be added thereto, to provide a water-tight seal around flange 16 over surface 30.

In one or more embodiments, the frame that partially covers the front panel 26 may be one-piece frame entirely surrounding a perimeter of the front panel, as shown in FIG. 6. Alternatively, it may be two or more pieces or strips that cover portions of the front panel 26. For instance, referring to FIG. 12. in certain embodiments the frame is two strips 2, 2 with a top frame strip 2 and a bottom frame strip 2, respectively, attached to a top and a bottom of the front panel. These strips 2, 2 may cover screws residing at top and bottom surfaces of the front panel 26 that secure the air pump station together and in position. In these embodiments, flange portions of front panel 26 and gasket 28 have corresponding screws holes for receiving screws therein to join the assembly together and flush mount the air station system into the hole or opening 32 in mounting surface 30. In one or more preferred embodiments, the mounting surface is the surface of a boat or RV, such that, the present air pump stations are permanently installed therein.

In accordance with the invention, the present air pump stations 10 of the invention allow for flush panel mounting for full integration into the boat/RV without allowing water ingress behind the mounting surface. It has been found that the air pump station 10 may include options to inflate and/or deflate ×3 stand up paddleboards within 7 (seven) minutes each, and features a pressure readout at LCD 24 where a pre-determined pressure is set to avoid over-inflation.

In accordance with the various embodiments the invention provides an easy and efficient air pump for inflating or deflating leisure inflatables from a permanently installed and integrated waterproof location onboard a boat/RV. The materials of the present air pump stations are all UV and temperature stable, as well as resistance to salt water, increasing the lifespan on the product in harsh marine environments. While embodiments of the invention are suitable for being permanently wired to a 12V boat/RV battery system, other embodiments are suitable for use with 12/24V, 24V and/or with maximum input currents of 10A with 15A fuses being suitable for use.

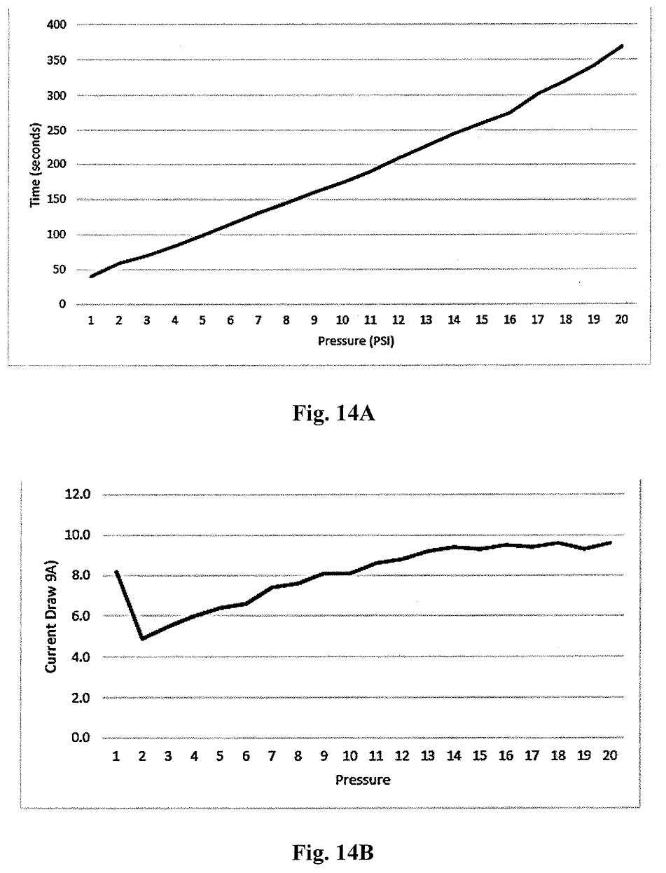

Referring to the inflation test of FIG. 14A it has been found that the present air pump stations have fast inflation times. For instance, comparative inflation tests found that the present air pump stations inflated a 10 ft.large inflatable Paddleboard at measures of 6 mins 9 seconds reaching 20 PSI, while a comparative portable prior art pump inflated that same device at 1.2 m hose and 20 PSI. Another comparative example was the inflation of a second inflatable Paddleboard device that inflated with the present air pumps 1 PSI in 1 min 17 seconds, as compared to a prior art pump of 1.5 PSI in 3 mins 30 seconds. FIG. 14B further shows that the present pump stations have acceptable inflation measures and pressures.

While the present invention has been particularly described, in conjunction with one or more specific embodiments, it is evident that many alternatives, modifications and variations will be apparent to those skilled in the art in light of the foregoing description. It is therefore 10 contemplated that the appended claims will embrace any such alternatives, modifications and variations as falling within the true scope and spirit of the present invention.

Thus, having described the invention, what is claimed is:

1. An air pump system permanently installed in a recreational vehicle comprising:
an air pump station having a frame, a front panel, an intermediate gasket, and a housing, housing having an outwardly extending housing flange around a periphery of the housing;
a water-tight seal formed by connection of the frame, the front panel, the intermediate gasket, and the outwardly extending housing flange of the housing, the water-tight seal preventing water ingress into the air pump station;
an air pump residing in the housing, the air pump having working components and circuitry for generating airflow and suction;
an outflow airflow connection of the air pump extending from within the housing and being exposed at a first opening in the front panel, the outflow airflow connection outputs air for inflating an inflatable device;
an inflow airflow connection of the air pump extending from within the housing and being exposed at a second opening in the front panel, the inflow airflow connection intakes air from an inflated device for deflating said inflated device;
a waterproof door residing on the front panel covering the outflow and inflow airflow connections and providing a watertight seal with a surface of the front panel to prevent water ingress into said outflow and inflow airflow connections;
an opening in a mounting surface of a moving vessel, the opening being sized and configured to fit the housing; and
a waterproof gasket residing at a backside of the housing, the housing extends through the opening in the mounting surface while the frame, front panel, intermediate gasket, housing flange, and waterproof gasket all reside above the mounting surface around said opening and are secured to the mounting surface to provide a water-tight seal around housing flange over the mounting surface.

2. The system of claim 1 wherein the housing comprises a tub-shaped housing.

3. The system of claim 1 wherein the frame comprises a one-piece frame entirely surrounding a perimeter of the front panel.

4. The system of claim 1 wherein the frame comprises a top frame strip and a bottom frame strip, respectively, attached to a top and a bottom of the front panel and covering screws residing in said top and bottom of the front panel that secure the air pump station together.

5. The system of claim 1 wherein the frame, the front panel, the intermediate gasket, and the outwardly extending housing flange of the housing are all correspondingly sized and configured to provide the water-tight seal.

6. The system of claim 5 further including providing a waterproof sealant between one or more of the frame, the front panel, the intermediate gasket, or the outwardly extending housing flange to enhance the water-tight seal.

7. The system of claim 1 further including an adapter at the back of the housing for connecting the air pump to a power source.

8. The system of claim 1 wherein the outflow airflow connection and the inflow airflow connection are adaptable to be fitted with a variety of different hoses and connectors for connection to the inflatable device.

9. The system of claim 1 wherein the waterproof door includes one or more seals at least on an outer periphery edge to provide said watertight seal.

10. The system of claim 1 wherein the waterproof door includes one or more hinges to ensure the waterproof door is closed when not in use, and preventing water from entering to the air pump inside the housing.

11. The system of claim 1 further including a pressure readout screen on the front panel.

12. The system of claim 11 further including one or more push buttons on the front panel for turning the air pump on and off, and for setting and controlling air pumping pressures.

13. The system of claim 1 wherein gasket has a width comparable to extension of the outwardly extending housing flange, and is provided with a waterproof adhesive to provide said water-tight seal around housing flange over the mounting surface.

14. The system of claim 1 wherein the moving vessel is a boat.

15. The system of claim 1 wherein the moving vessel is a land recreational vehicle (RV).

16. A method of forming an air pump system in a recreational vehicle comprising providing an air pump station having a frame, a front panel, an intermediate gasket, a housing having an air pump therein, a housing flange, a waterproof gasket, an outflow airflow connection, an inflow airflow connection, and a waterproof door residing on the front panel covering the outflow and inflow airflow connections and providing a watertight seal with a surface of the front panel to prevent water ingress into said outflow and inflow airflow connections,
providing an opening in a mounting surface of a moving vessel, the opening being sized and configured to fit the housing; and
permanently affixing the air pump station to the mounting surface in a watertight connection whereby the waterproof gasket resides at a backside of the housing, the housing extends through the opening in the mounting surface while the frame, front panel, intermediate gasket, housing flange, and the waterproof gasket all reside above the mounting surface around said opening and are secured to the mounting surface to provide a water-tight seal around housing flange over the mounting surface,
whereby the waterproof door includes one or more hinges to ensure the waterproof door is closed when not in use, and preventing water from entering to the air pump inside the housing.

17. The system of claim 16 wherein the moving vessel is a boat or a land recreational vehicle (RV).

18. A method for inflating and deflating an inflatable device comprising:
providing an air pump station having a frame, a front panel, an intermediate gasket, a housing having an air pump therein, a housing flange, a waterproof gasket, an outflow airflow connection, an inflow airflow connection, and a waterproof door residing on the front panel covering the outflow and inflow airflow connections and providing a watertight seal with a surface of the front panel to prevent water ingress into said outflow and inflow airflow connections, the air pump station is permanently affixed to a mounting surface in a watertight connection whereby the waterproof gasket resides at a backside of the housing, the housing extends through an opening in the mounting surface while the frame, front panel, intermediate gasket, housing flange, and the waterproof gasket all reside above the mounting surface around said opening and are secured to the mounting surface to provide a water-tight seal around housing flange over the mounting surface;
providing a hose and a connector; and
inflating or deflating an inflatable device by connecting the hose via the connector to the outflow airflow connection for outputting air to inflate an inflatable device or to the inflow airflow connection for intaking air to deflate an inflated device.

19. The system of claim 18 wherein the mounting surface is on a boat.

20. The system of claim 18 wherein the mounting surface is on a land recreational vehicle (RV).
